(19) United States
(12) Patent Application Publication
(10) Pub. No.: US 2023/0045850 A1
(43) Pub. Date: Feb. 16, 2023

(54) Fingerprint Capturing and Matching for Authentication

(71) Applicant: Google LLC, Mountain View, CA (US)

(72) Inventors: Firas Sammoura, Dublin, CA (US); Jean-Marie Bussat, San Jose, CA (US)

(73) Assignee: Google LLC, Mountain View, CA (US)

(21) Appl. No.: 17/784,367

(22) PCT Filed: Dec. 12, 2019
(86) PCT No.: PCT/US2019/066077

§ 371 Date: Jun. 10, 2022

(51) Int. Cl. G06F 21/32

(52) U.S. Cl. CPC G06F 21/32

(57) ABSTRACT

This disclosure describes techniques for parallel fingerprint capturing and matching, thereby enabling large-area or high-resolution fingerprint identification with low latency. Rather than waiting to capture an entire fingerprint image (“a verify image”), a fingerprint identification process divides the verify image into blocks and attempts to match the blocks to corresponding portions of an enrolled image even as other portions are being. Rather than waiting to capture and analyze the entire fingerprint image at once, small groups of blocks are captured and the already-captured blocks are matched and scored to corresponding blocks of an enrolled image, in some cases, while additional blocks of the verify image are being captured. A cumulative score and cumulative confidence in the overall matching of the enrolled image is derived from the scores and confidences of the individual block scores and the verify image is authenticated based on each satisfying their respective thresholds.

### BACKGROUND

A user device may use a fingerprint sensor of a fingerprint system (e.g., an Automatic Fingerprint Identification System, AFIS), to capture a fingerprint image, referred to as a “verify image”. From the verify image, the fingerprint system identifies patterns of small features (minutiae) of the fingerprint image. Using these minutiae, the fingerprint system can authenticate a user. Accurately authenticating a user, however, is difficult if the verify image is not sufficiently large in size or high in resolution, as small-sized or lower-resolution images have fewer discernable minutiae with which to compare features of the verify image with previously stored minutiae for that user. Thus, more-accurate or more-robust verification is permitted with higher-resolution or larger-area verify images. Capturing larger or higher-resolution verify images, however, can take noticeably longer for the fingerprint system, increasing an amount of time that a user must wait to be verified. Further still, matching greater numbers of minutiae also requires greater processing by the user device, which can also increase the user's wait time.

This wait time has been a substantial problem for device makers, causing many of them to abandon a fingerprint authentication system entirely or to use smaller or lower-resolution verification images. While using smaller or lower-resolution verification images sometimes permit faster authentication, doing so is less accurate, and thus less secure, or require users to often make multiple fingerprint inputs (e.g., swipes over the sensor). All of these partial solutions fail to provide an excellent user experience.

### SUMMARY

To address flaws in current automatic fingerprint identification systems, this disclosure describes techniques for parallel fingerprint capturing and matching, thereby enabling large-area or high-resolution fingerprint identification with low latency (i.e., quickly). Rather than wait to capture an entire fingerprint image (“a verify image”), the fingerprint identification process divides the verify image into blocks and attempts to match the blocks to corresponding portions of an enrolled image. Small groups of blocks are captured one at a time. Rather than waiting to capture and analyze the entire fingerprint image at once, the already-captured blocks are matched and scored to corresponding blocks of an enrolled image, while additional blocks of the verify image are being captured. The individual block scores are compiled and ranked as additional blocks of the verify image are captured. A cumulative score and cumulative confidence in the overall matching of the enrolled image are derived from the scores and confidences of the individual block scores. The verify image is authenticated in response to the cumulative score and cumulative confidence each satisfying their respective thresholds.

As this capturing-and-scoring process repeats, the highest-ranking block scores are combined to produce an overall score indicating whether the fingerprint in the verify image matches the enrolled image. Confidence in the overall score increases with confidence in the individual block scores. As more blocks are captured and matched, the confidence in the overall image score may increase. Eventually, the confidence may satisfy a confidence threshold for matching the fingerprint image to the enrolled image. The techniques enable simultaneous capturing and matching of different parts of the fingerprint input (e.g., image or other data from a sensor) without increasing complexity, reducing latency in some cases.

In some aspects a computer-implemented method is described including detecting, by a user device, a fingerprint input at a fingerprint sensor; and while capturing, with the fingerprint sensor, portions of the fingerprint input, the portions representing individual blocks of the fingerprint input: scoring the captured individual blocks against respective enrolled blocks of an enrolled fingerprint input of an enrolled user; incrementally determining, based on respective scores of the captured individual blocks, a confidence that the fingerprint input matches the enrolled fingerprint input; and in response to the confidence satisfying a threshold, authenticating the fingerprint input.

In some aspects another computer-implemented method is described. The other method includes capturing, by a fingerprint sensor of a user device, a portion of a large-area or high-resolution image of a fingerprint provided by a user. Without regard to capturing other portions of the large-area or high-resolution image of the fingerprint, the method includes: dividing the captured portion of the large-area or high-resolution image into blocks, analyzing a first subset of the blocks for first minutiae, comparing the analyzed first minutiae against enrolled minutiae associated with an enrolled user of the user device, and determining a first confidence score based on the comparing of the analyzed first minutiae against enrolled minutiae associated with the enrolled user of the user device. Still without regard to capturing other portions of the large-area or high-resolution image of the fingerprint, the method includes: responsive to the first confidence score failing to meet a threshold: analyzing a second subset of the blocks for second minutiae, comparing the analyzed second minutiae against enrolled minutiae associated with the enrolled user of the user device, determining a second confidence score based on the comparing of the analyzed second minutiae against enrolled minutiae associated with an enrolled user of the user device, and responsive to the second confidence score meeting the threshold or a compilation of the first and second confidence scores meeting the threshold, authenticating the enrolled user.

This document also describes computer-readable media having instructions for performing the above-summarized methods. Other methods are set forth herein, as well as systems and means for performing the above-summarized and other methods.

Throughout the disclosure, examples are described where a computing system (e.g., a user device) analyzes information (e.g., fingerprint images) associated with a user or a user device. The computing system uses the information associated with the user after the computing system receives explicit permission from the user to collect, store, or analyze the information. For example, in situations discussed below in which a user device authenticates a user based on fingerprints, the user will be provided with an opportunity to control whether programs or features of the user device or a remote system can collect and make use of the fingerprint for a current or subsequent authentication procedure. Individual users, therefore, have control over what the computing system can or cannot do with fingerprint images and other information associated with the user. Information associated with the user (e.g., an enrolled image), if ever stored, is pre-treated in one or more ways so that personally identifiable information is removed before being transferred, stored, or otherwise used. For example, before a user device stores an enrolled image (also referred to as “a fingerprint template”), the user device encrypts the enrolled image. Pre-treating the data this way ensures the information cannot be traced back to the user, thereby removing any personally identifiable information that would otherwise be inferable from the enrolled image. Thus, the user has control over whether information about the user is collected and, if collected, how such information may be used by the computing system.

This summary is provided to introduce simplified concepts for parallel fingerprint capturing and matching, which is further described below in the Detailed Description and Drawings. For ease of description, the disclosure focuses on fingerprint capturing and matching. However, the techniques are not limited to fingerprint identification on hands and feet; the techniques also apply to other forms of biometric identification, such as for facial recognition or retinal identification. This summary is not intended to identify essential features of the claimed subject matter, nor is it intended for use in determining the scope of the claimed subject matter.

### BRIEF DESCRIPTION OF THE DRAWINGS

The details of one or more aspects of parallel fingerprint capturing and matching are described in this document with reference to the following drawings. The same numbers are used throughout the drawings to reference like features and components:

FIG. 1 illustrates an example user device that authenticates user inputs using parallel fingerprint capturing and matching.

FIG. 2 illustrates another example user device that authenticates user inputs using parallel fingerprint capturing and matching.

FIG. 3 illustrates an example of a fingerprint identification system that implements parallel fingerprint capturing and matching.

FIG. 4 illustrates aspects of parallel fingerprint capturing and matching performed by a user device that authenticates fingerprints.

FIG. 5-1 illustrates an example logic-flow diagram of a capturing module of the fingerprint identification system of FIG. 3.

FIG. 5-2 illustrates an example logic-flow diagram of a matching module of the fingerprint identification system of FIG. 3.

FIG. 6 illustrates an example method performed by a user device that authenticates user inputs using parallel fingerprint capturing and matching.

FIG. 7 illustrates an example of a fingerprint identification system that implements parallel fingerprint capturing and matching with multiple sensors.

FIG. 8 illustrates an example capturing path of the fingerprint identification system of FIG. 7.

FIG. 9 illustrates an example of a fingerprint identification system that implements parallel fingerprint capturing and matching of multiple fingerprints along separate capturing paths.

FIG. 10 illustrates examples of minutiae used in matching fingerprints.

### DETAILED DESCRIPTION

The details of one or more aspects of parallel fingerprint capturing and matching are described below. In summary, this document describes techniques that enable large-area fingerprint sensors to simultaneously capture a fingerprint and match it to a template image (e.g., an enrolled image).

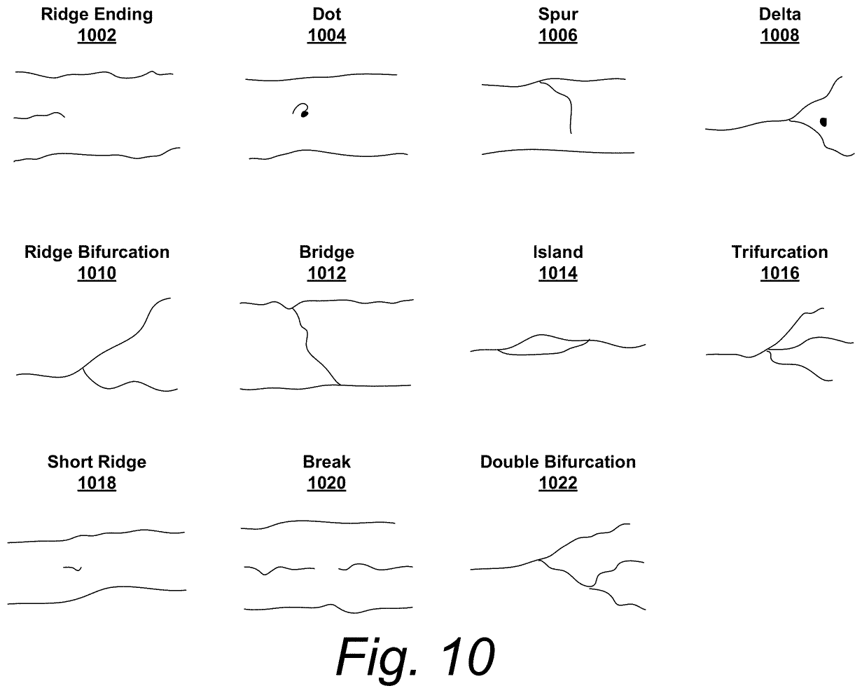

In practice, a user device (e.g., a mobile telephone, a tablet computer, a wristwatch) may use a fingerprint sensor to capture a verify image and match the minutiae visible from the verify image to an enrolled image. For examples of minutiae used in matching fingerprints see FIG. 10 and the supporting description below. When the user device uses a large-area fingerprint sensor, minutiae matching is achieved with high success. With more detail in a large fingerprint image, it is possible to make a more-accurate identification. However, capturing an entire fingerprint can take a long time, particularly if the capturing is done at high resolution or over a large-area.

Some user devices cannot afford the latency or processing power required to work with large area or high-resolution fingerprint images. Size constraints of the device may limit the size of the fingerprint sensor as well. Matching based on ridge flow maps derived from larger verify images taken from larger fingerprint sensors becomes temporally and computationally less efficient as sizes of the verify images increase. As such, large-area or high-resolution fingerprint identification may not be feasible in some lower performance applications given potential latency issues and demand for processing resources for the fingerprint identification.

Instead, some user devices use small-area fingerprint sensors, which decreases the number of minutiae available for identification. These user devices struggle to identify positive minutiae matches when only a few minutiae are visible in each iteration of a scan. Reliance on a small-area fingerprint sensor is one of the reasons why many user devices perform pattern-correlation matching, instead of minutiae matching, often attempting to correlate an entire fingerprint at once. First, the user device tries to match the alignment and the orientation of an entire verify image of a fingerprint. Then the user device correlates the entire verify image to an entire enrolled image. This technique is not realistically scalable and cannot easily support large-area, such as several square centimeters or high-resolution fingerprint images, such as resolutions of a thousand Dots-Per-Inch (DPI).

To this end, some systems use a hybrid type of fingerprint matching to increase the image size or resolution and the fingerprint-matching success rate. These systems “fuse” minutiae and pattern-correlation matching to capture and match fingerprints much faster than using either technique alone. It will be made apparent from the following description and accompanying figures, how this matching technique can be adapted to enable parallel capturing and matching.

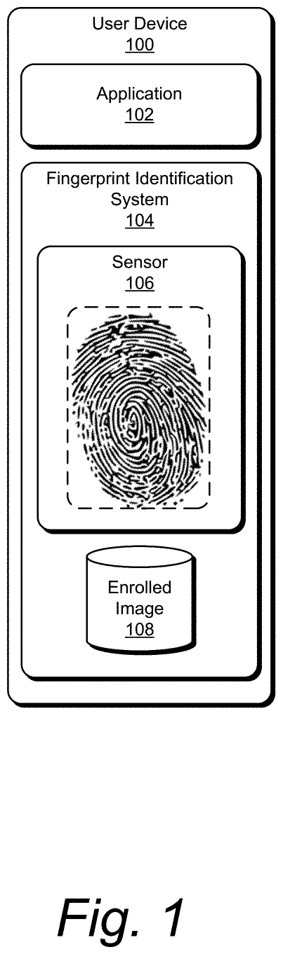

FIG. 1 illustrates an example of a user device 100 that authenticates a user input using parallel fingerprint capturing and matching. As described below, the user device 100 fuses minutiae matching with pattern-correlation matching. Through parallel capturing and matching, the user device 100 can perform fast fingerprint identification, often taking less time than a traditional fingerprint identification system because, unlike a traditional system, the matching occurs while the capturing is also happening.

The user device 100 may be any mobile or non-mobile computing device. As a mobile computing device, the user device 100 can be a mobile phone, a laptop computer, a wearable device (e.g., watches, eyeglasses, headphones, clothing), a tablet device, an automotive/vehicular device, a portable gaming device, an electronic reader device, or a remote-control device, or other mobile computing device that relies on fingerprint identification to perform a function. As a non-mobile computing device, the user device 100 may represent a server, a network terminal device, a desktop computer, a television device, a display device, an entertainment set-top device, a streaming media device, a tabletop assistant device, a non-portable gaming device, business conferencing equipment, a payment station, a security checkpoint system, or other non-mobile computing device including a fingerprint identification system like a fingerprint identification system 104.

The user device 100 includes an application 102, the fingerprint identification system 104, including a sensor 106, and an enrolled image 108. These and other components of the user device 100 are communicatively coupled in various ways, including through the use of wired and wireless buses and links. The user device 100 may include additional or fewer components than what is shown in FIG. 1.

The application 102 can be a secured component of the user device 100 or an access point to secure information accessible from the user device 100. The application 102 may be an online banking application or webpage that requires fingerprint identification before logging in to an account. Or, the application 102 may be part of an operating system that prevents access (generally) to the user device 100 until the user's fingerprint is identified. Many other examples of the application 102 exist. The application 102 may execute partially on the user device 100 and partially in “the cloud” (e.g., on the Internet). For example, the application 102 may provide an interface to an online account, such as through an internet browser or an application programming interface (API).

The sensor 106 can be any sensor able to capture an image of a fingerprint. The sensor 106 may be an in-display touch sensor, a capacitive touch sensor, or a touch sensor module for standalone biometric identification, such as iris identification or other biometric identification techniques. For ease of description, sensor 106 is generally described as being integrated with a display that presents a graphical user interface (GUI). The GUI may include instructions for the user to follow to authenticate themselves with the sensor 106. For example, the GUI may include a target graphical element (e.g., an icon, a designated region) where the user is to touch the display to provide their fingerprint.

The enrolled image 108 represents a predefined, user-specific fingerprint image template. The fingerprint identification system 104 records the enrolled image 108 in advance during a coordinated setup session with the user device 100 and a particular user. The user device 100 instructs the user via the GUI to press a finger on the sensor 106 one or more times until the fingerprint identification system 104 has an accurate image of the user's fingerprint, which the user device 100 retains as an enrolled image 108.

The fingerprint identification system 104 captures individual blocks of the fingerprint that are recognizable from user input at the sensor 106. The fingerprint identification system 104 uses minutiae matching, pattern-correlation, or both, to extract individual blocks initially captured by the sensor 106 that could indicate a match to corresponding blocks of the enrolled image 108. Rather than wait for the sensor 106 to capture additional blocks of the fingerprint image, the fingerprint identification system 104 matches the blocks that have already been captured to blocks of the enrolled image 108 while the fingerprint authentication system 104 continues to capture additional blocks for subsequent matching.

As one example, the user device 100 detects a user input at the sensor 106. The fingerprint identification system 104 divides the user input into a quantity of M groups of blocks with a sliding distance of one pixel between blocks. The fingerprint identification system 104 divides the enrolled image into the quantity of M groups of blocks P′ with the sliding distance of one pixel between blocks as well. The fingerprint identification system 104 can extract fewer than M number of blocks with a sliding distance greater than one pixel and increase computation speed by evaluating part of the full image during each iteration of the fingerprint capture. In other words, the sensor 106 captures only some of the individual blocks Mat a time. Referred to as the blocks P, the blocks P include fewer individual blocks than the total blocks M.

The fingerprint identification system 104 scores each of the captured individual blocks P against corresponding blocks P′ of the enrolled image 108. For example, by transforming the blocks P of the fingerprint image into rotationally-invariant vectors, the fingerprint identification system 104 compares closest matching rotationally-invariant vectors of the blocks P′ of the enrolled image 108 in any direction. The outcome of these vectors' transformation will be the same and mapped to the same vectors regardless of the orientation. Essentially, the fingerprint identification system 104 replaces the minutiae with a pattern but treats the pattern like minutiae by assigning a location and an orientation to the pattern.

The fingerprint identification system 104 extracts vectors from each captured blocks, including the following:

Rotationally invariant Absolute-value Fast Fourier Transforms (AFFTs) of each block;

The blocks' x-position and y-position—the Cartesian coordinates;

The blocks' polar representation of the Cartesian coordinates; and

The blocks' Fast Fourier Transforms (FFTs) of the polar representation with a high resolution in the theta (Θ) direction. The fingerprint identification system 104 determines respective scores of the captured individual blocks P from the vectors, and a confidence that the individual blocks P match those blocks P′ of the enrolled image 108. Based on the scores and confidences of the individual blocks, the fingerprint identification system 104 iteratively computes a confidence and a score for the user input relative to the enrolled image 108.

The fingerprint identification system 104 repeats by capturing more and more blocks P, extracting the above-mentioned vectors from each capture along the way. The fingerprint identification system 104 updates the confidence and score that the user input matches the enrolled image 108 based on the additional vectors extracted from each additional captured block P. If during this iterative process, the confidence in the user input fails to satisfy a confidence threshold, the user input is marked unidentifiable or unrecognized. However, if at any time prior to or after capturing all the individual blocks M, the fingerprint identification system 104 determines that the confidence and score of the user input satisfy respective thresholds, the fingerprint identification system 104 automatically matches the user input to the enrolled image 108, thereby authenticating the user input and granting access to the application 102 without having to capture an entire fingerprint image.

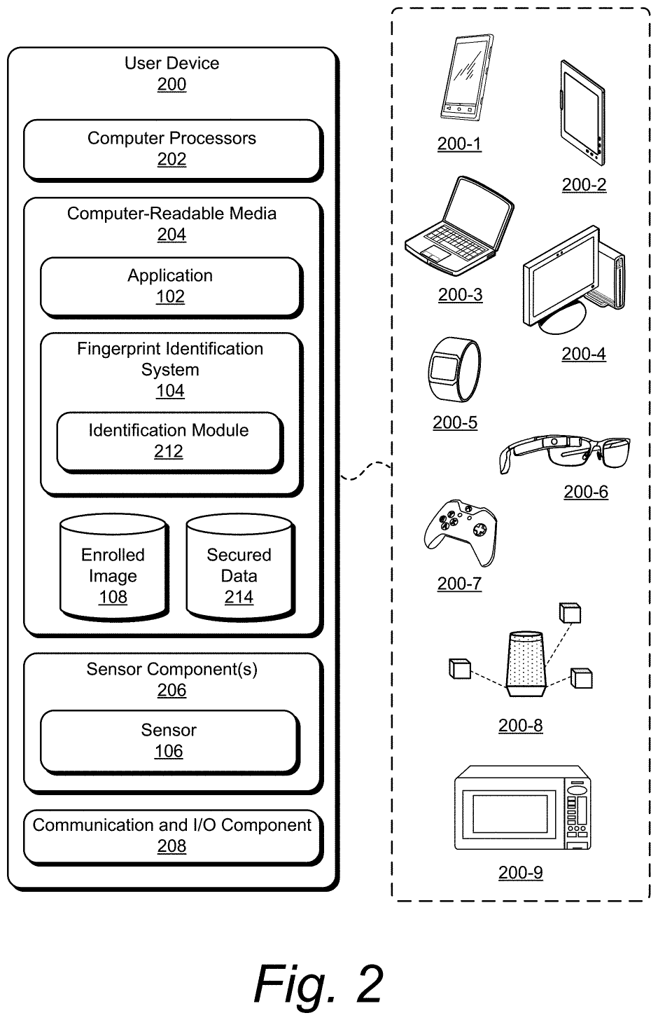

FIG. 2 illustrates another example user device 200 that authenticates user inputs using parallel fingerprint capturing and matching. The user device 200 is an example of the user device 100 set forth in FIG. 1. FIG. 2 shows the user device 200 as being a variety of example devices, including a smartphone 200-1, a tablet 200-2, a laptop 200-3, a desktop computer 200-4, a computing watch 200-5, computing eyeglasses 200-6, a gaming system or controller 200-7, a smart speaker system 200-8, and an appliance 200-9. The user device 200 can also include other devices, such as televisions, entertainment systems, audio systems, automobiles, unmanned vehicles (in-air, on the ground, or submersible “drones”), trackpads, drawing pads, netbooks, e-readers, home security systems, doorbells, refrigerators, and other devices with a fingerprint identification system.

The user device 200 includes one or more computer processors 202 and one or more computer-readable media 204, and one or more sensor components 206. The user device 200 further includes one or more communication and input/output (I/O) components 208, which can operate as an input device and/or an output device, for example, presenting a GUI and receiving inputs directed to the GUI. The one or more computer-readable media 204 include the application 102, the fingerprint identification system 104, the enrolled image 108, and a secured data store 214. In the user device 200, the fingerprint identification system 104 includes an identification module 212. Other programs, services, and applications (not shown) can be implemented as computer-readable instructions on the computer-readable media 204, which can be executed by the computer processors 202 to provide functionalities described herein. The computer processors 202 and the computer-readable media 204, which include memory media and storage media, are the main processing complex of the user device 200. The sensor 106 is included as one of the sensor components 206.

The computer processors 202 may include any combination of one or more controllers, microcontrollers, processors, microprocessors, hardware processors, hardware processing units, digital-signal-processors, graphics processors, graphics processing units, and the like. The computer processors 202 may be an integrated processor and memory subsystem (e.g., implemented as a “system-on-chip”), which processes computer-executable instructions to control operations of the user device 200.

The computer-readable media 204 is configured as persistent and non-persistent storage of executable instructions (e.g., firmware, software, applications, modules, programs, functions) and data (e.g., user data, operational data, online data) to support execution of the executable instructions. Examples of the computer-readable media 204 include volatile memory and non-volatile memory, fixed and removable media devices, and any suitable memory device or electronic data storage that maintains executable instructions and supporting data. The computer-readable media 204 can include various implementations of random-access memory (RAM), read-only memory (ROM), flash memory, and other types of storage memory in various memory device configurations. The computer-readable media 204 excludes propagating signals. The computer-readable media 204 may be a solid-state drive (SSD) or a hard disk drive (HDD).

In addition to the sensor 106, the sensor components 206 include other sensors for obtaining contextual information (e.g., sensor data) indicative of operating conditions (virtual or physical) of the user device 200 or the user device 200's surroundings. The user device 200 monitors the operating conditions based in part on sensor data generated by the sensor components 206. In addition to the examples given for the sensor 106 to detect fingerprints, other examples of the sensor components 206 include various types of cameras (e.g., optical, infrared), radar sensors, inertial measurement units, movement sensors, temperature sensors, position sensors, proximity sensors, light sensors, infrared sensors, moisture sensors, pressure sensors, and the like.

The communication and I/O component 208 provides connectivity to the user device 200 and other devices and peripherals. The communication and I/O component 208 includes data network interfaces that provide connection and/or communication links between the device and other data networks, devices, or remote systems (e.g., servers). The communication and I/O component 208 couples the user device 200 to a variety of different types of components, peripherals, or accessory devices. Data input ports of the communication and I/O component 208 receives data, including image data, user inputs, communication data, audio data, video data, and the like. The communication and I/O component 208 enables wired or wireless communicating of device data between the user device 200 and other devices, computing systems, and networks. Transceivers of the communication and I/O component 208 enable cellular phone communication and other types of network data communication.

The identification module 212 directs the fingerprint identification system 104 to perform parallel capturing and matching of fingerprints detected at the sensors 206. In response to receiving an indication that the sensors 206 detect a user input, the identification module 212 obtains some of the individual blocks of the user input being captured by the sensor 106 and scores each of the captured individual blocks against different blocks of the enrolled image 108. As the identification module 212 directs the sensor 106 to capture additional individual blocks, the identification module 212 compiles the scores of the individual blocks already captured and generates from the scores, a confidence value associated with the user input. In some cases, prior to capturing all the individual blocks of the user input, and as soon as the confidence satisfies a threshold, the identification module 212 automatically matches the user input to the enrolled image 108 and authenticates the user input.

In response to the identification module 212 outputting an indication that a fingerprint is identified and matched to the user, the application 102 may grant the user access to the secured data store 214. Otherwise, the identification module 212 outputs an indication that fingerprint identification failed, and the user is restricted from having access to the secured data store 214.

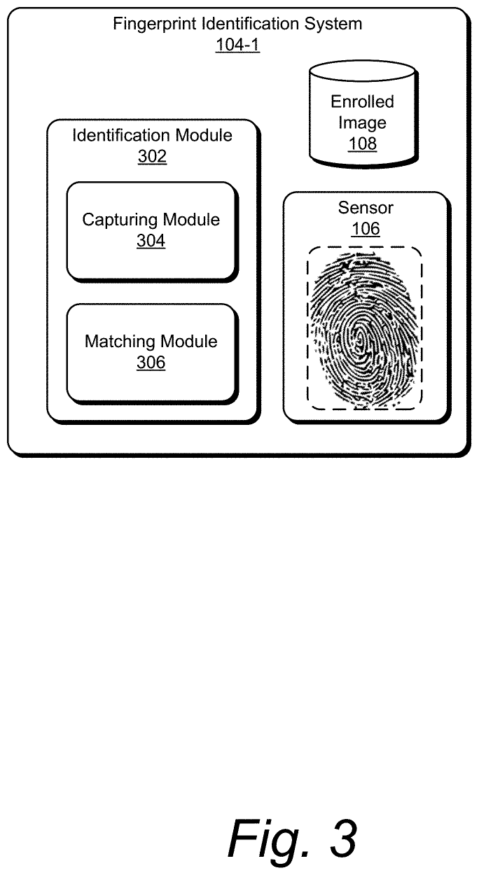

FIG. 3 illustrates an example of a fingerprint identification system 104-1 that implements parallel fingerprint capturing and matching. Similar to the fingerprint identification system 104, the fingerprint identification system 104-1 includes the enrolled image 108 and the sensor 106. The fingerprint identification system 104-1 further includes identification module 302, which includes a capturing module 304 and a matching module 306.

The capturing module 304 captures a user input at the sensor 106 at the direction of identification module 302. The matching module 306 attempts to match the output from the capturing module 304 to the enrolled image 108. Instead of waiting for the capturing module 304 to capture an entire fingerprint, the matching module 306 immediately scores previously captured blocks against blocks of the enrolled image 108, and the scores R are tracked as new blocks P are captured by the capturing module 304. The matching module 306 determines, based on the confidences and scores R associated with the individual blocks P, an overall composite score S and confidence C associated with the user input matching the enrolled image 108.

The matching module 306 uses the highest-ranking individual block scores to produce the overall score S indicating whether the fingerprint matches the enrolled image 108. The matching module 306 maintains the confidence C in the overall score S and the confidence C increases as the confidence in the highest-ranking individual block scores also increase. As more blocks are captured and matched, the confidence C in the overall image score grows. The matching module 306 determines whether or not the confidence C satisfies a confidence threshold for matching the fingerprint image to the enrolled image 108. Rather than wait for the capturing module 304 to capture an entire image, the fingerprint is authenticated as soon as the score S and its confidence C satisfy their respective thresholds. This enables parallel capturing and matching of different parts of the fingerprint image without increasing complexity and in some cases, with reducing latency.

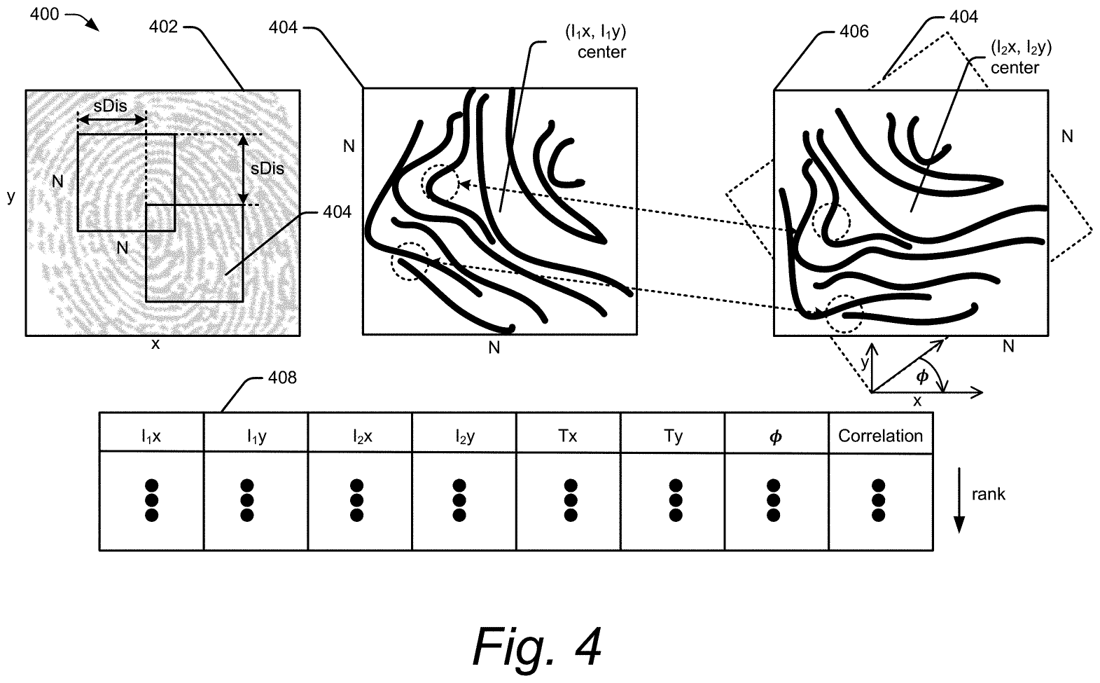

FIG. 4 illustrates aspects of parallel fingerprint capturing and matching techniques performed by a user device that authenticates fingerprints. FIG. 4 is described in the context of the fingerprint identification system 104-1. FIG. 4 includes verify image 402 is divided into M groups of blocks P, including block 404. Each of the N×N (where N is an integer) blocks P, including block 404, is separated from another block by separation distances sDIS (e.g., one pixel). FIG. 4 further includes an N×N sized block 406 of the enrolled image 108 and a ranked table 408.

The angular rotation around the center points of blocks 404 and 406 in Cartesian coordinates (I₁x, I₁y) and (I₂x, I₂y), respectively, transforms into a translation along the theta Θ) direction in the polar coordinate representation—this is called “phase shifting.” FFTs assume periodic boundary conditions. As such, the AFFT of the block 404 represented in polar coordinates is rotationally invariant, and the rotation angle of the block 404 is the location of the maximum correlation between the FFT of the blocks 404 and 406, represented in polar coordinates.

The rotational and translation matrices, where the rotation and translation matrix between the two images 404 and 406 can be defined as:

(cos(ϕ)sin(ϕ)−Tₓ−sin(ϕ)cos(ϕ)−T_{y}001)

where ϕ represents the angle between the center points (I₁x, I₁y) and (I₂x, I₂y) in Cartesian coordinates for the two images 404 and 406, Tₓ represents the translation along the x-axis between the two images 404 and 406, and T_{y} represents the translation along the y-axis between the two images 404 and 406.

The x-coordinates and the y-coordinates of image 406 can be transformed into the coordinate system of image 404 using Equation 1.

(x′y′1)=(cos(ϕ)sin(ϕ)−Tₓ−sin(ϕ)cos(ϕ)−T_{y}001)(xy1) (Equation 1)

Furthermore, the rotation matrix between the blocks 404 and 406, herein called RM₁₂, is the inverse of the rotation matrix between the blocks 404 and 406, herein called RM₂₁, as shown in Equation 2.

RM₁₂=(RM₂₁)⁻¹ (Equation 2)

The capturing module 304 determines a similarity between the vectors of the verify blocks 404 and the vectors of the enrolled blocks 406 along with the angle of rotation ϕ and the correlation. The matching module 306 then extracts the x-coordinate, the y-coordinate, and the angle correspondence in the output from the capturing module 304 and calculates the translation in the x-direction and y-direction for each block of the verify image.

At this stage, the matching module 306 merges vectors from the enrolled images using a rotation and translation matrix and drops redundant vectors based on a quality-score. The matching module 306 drops redundant vectors using this quality-score to rank the highest (e.g., top ten) translation and rotation vectors. The ranked table 408 represents a data structure (table) that the matching module 306 may use to maintain the highest-ranking translation and rotation vectors.

The outcome of the matching is the number of matching blocks between the verify image 402 and the enrolled image 406 that show similar translation and rotation. To increase the robustness of the matching, a small error is allowed in the translation and rotation to account for variations due to skin-plasticity distortions.

These parallel capturing and matching techniques can be used for other forms of biometric matching, such as iris, palmprint, and footprint. One area where parallel capturing and matching techniques tend to fail is when attempting to match a perfect pattern (e.g., a perfect zebra pattern) because, in that case, each block from the enrolled and a verified image is identical. This limitation, however, becomes irrelevant because biometric patterns are not perfect. It is that imperfection and uniqueness that gives the biometric pattern and these parallel capturing and matching techniques their value.

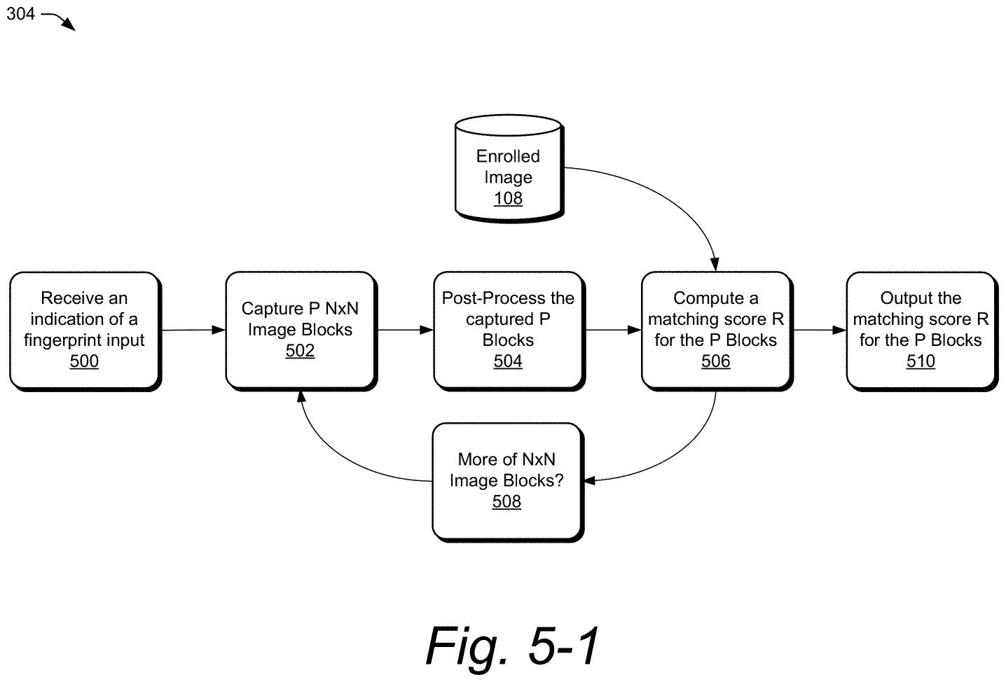

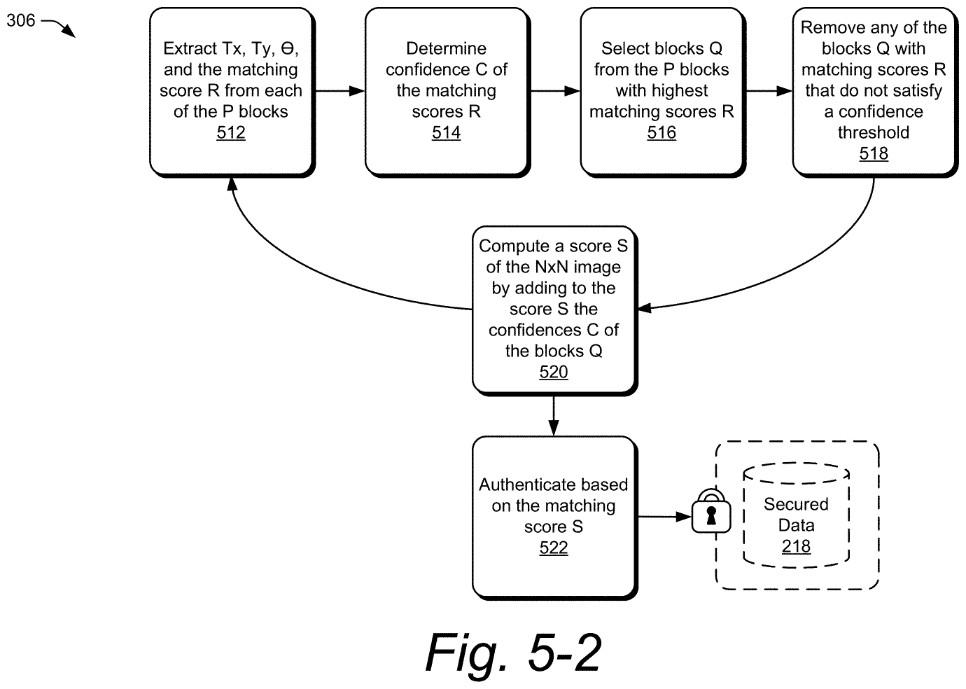

FIG. 5-1 illustrates an example logic-flow of the capturing module 304 of the fingerprint identification system of FIG. 3. FIG. 5-2 illustrates an example logic-flow of the matching module 306 of the fingerprint identification system of FIG. 3.

The logical operations of the capturing module 304 are organized in stages 500 through 510. As illustrated in FIG. 5-1, at stage 500, the capturing module 304 receives an indication of a fingerprint touch at the sensor 106. Rather than direct the sensor 106 to capture the entire user input, the sensor 106 captures only some blocks P of the user input. User input at the sensor 106 triggers the capturing module 304 to capture blocks P of the user input at stage 502, including the block 404.

At stage 504, the capturing module 304 runs the blocks P of the user input through post-processing, where the images of the blocks P are enhanced for the subsequent stage 506 where the capturing module 304 computes an individual matching score R for each of the blocks P. At stage 510, the capturing module 304 outputs the matching scores R for the blocks P to be used by the matching module 306 for fingerprint identification. At stage 508, the capturing module 304 determines whether there are still more blocks P to be captured, and if so, the capturing module 304 captures additional blocks P of the user input and repeats stages 504 through 510 accordingly.

Turning to FIG. 5-2, the matching module 306 may perform the logical operations of stages 512 through 522. At stage 512, the matching module 306 receives the output from the capturing module 304 and extracts Tₓ, T_{y}, θ, and the matching score R from each of the blocks P.

The matching module 306 extracts translation vectors Tₓ and T_{y} in both x and y directions for the blocks P. The matching module 306 also extracts a rotational vector ϕ based on a calculated rotation angle θ between the blocks P and matching blocks of the enrolled image 108. The matching module 306 retains the Tₓ, T_{y}, θ, and the matching score R from each of the blocks P at the ranked table 408. The matching module 306 sorts the translation vectors in the ranked table 408 based on matching scores R, and groups multiple matching blocks with the closest rotation and translation vectors into bins.

At stage 514, the matching module 306 determines a confidence C of the matching scores R. The rotation and translation vector candidates [Tₓ, T_{y}, ϕ] are subjected to a random sample consensus (RANSAC) voting process to determine a correlation/matching score between the matching blocks. The higher the number of votes, the greater the correlation/matching score, and the greater the confidence C. The matching module 306 sorts the translation vectors using the correlation/matching scores within the ranked table 408. The matching module 306 groups multiple matching blocks P with the closest rotation and translation vectors into bins of blocks Q.

The matching module 306 selects the bins of blocks Q with the highest matching scores R at stage 516. At stage 518, the matching module 306 discards the bins of blocks Q with matching scores or confidences that do not satisfy a confidence threshold. At 520, the matching module 306 computes a composite score S and confidence C for the verify image, based on the scores R and confidences of the blocks Q in the highest-ranking bin. The matching module 306 selects a bin from the ranked table 408 with the highest quantity of matching blocks Q and extracts a final translational and rotation vector [Tₓ, T_{y}, ϕ] for the verify image, which is calculated as the average of the rotation and translation vectors of all the matching blocks Q within the bin.

After stage 520, the matching module 306 returns to stage 512 unless the confidence of the matching blocks Q within the bin satisfy a confidence threshold. At stage 522, the matching module 306 outputs a successful authentication if the total quantity of votes in the highest-scoring bin is greater than a threshold, granting access to the secured data 218.

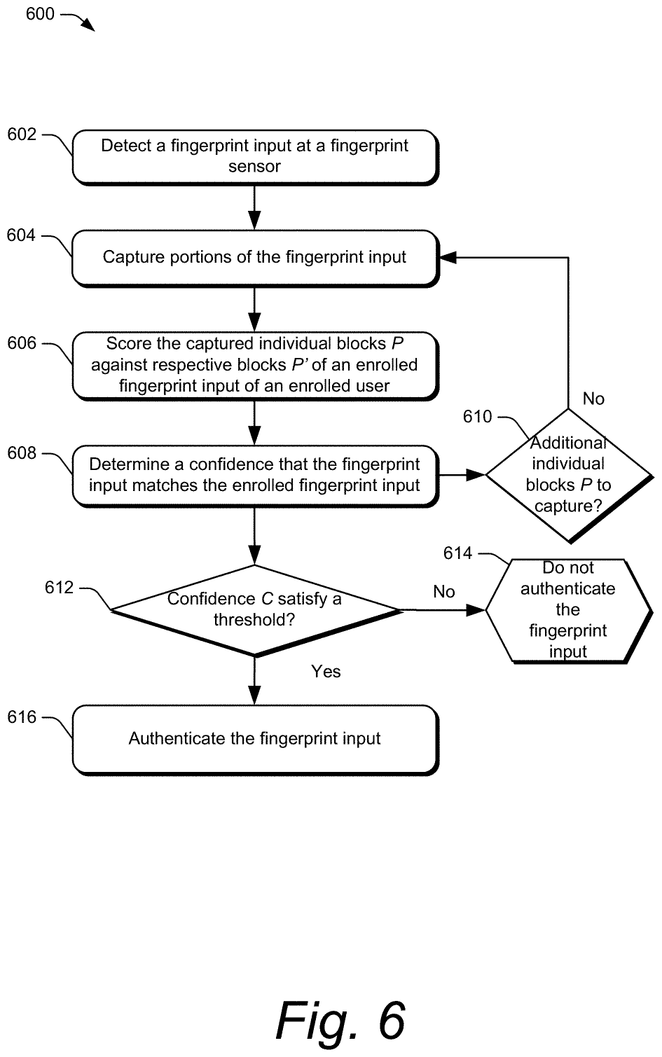

FIG. 6 illustrates an example method 600 performed by a user device that authenticates user inputs using parallel fingerprint capturing and matching. FIG. 6 is described in the context of FIG. 1, and user device 100. The operations performed in the example method 600 may be performed in a different order or with additional or fewer steps than what is shown in FIG. 6.

At 602, the user device 100 detects a fingerprint input at a fingerprint sensor. The sensor 106 may provide an indication of the fingerprint input to the fingerprint identification system 104, which triggers the fingerprint identification system 104 to identify a fingerprint from the fingerprint input. The fingerprint input is divided into multiple blocks M.

At 604, the user device 100 captures portions of the fingerprint input, the portions representing individual blocks of the fingerprint input. For example, rather than capturing an entire fingerprint, the fingerprint identification system 104 captures blocks P of the multiple blocks M, where P is less than M.

At 606, the user device 100 scores each of the captured individual blocks P against respective enrolled blocks P′ of an enrolled image of an enrolled user. For example, for each of the captured individual blocks P, the fingerprint identification system 104 determines a rotational invariant vector relative to a closest matching block P′ from the enrolled image 108. The fingerprint identification system 104 selects, based on the rotational invariant vectors and from the corresponding blocks P′ of the enrolled image 108, the closest matching block Q for each of the captured individual blocks P.

At 608, the user device 100 determines, based on respective scores R of the captured individual blocks P, a confidence C that the user input matches the enrolled image 108. The user device 100 can determine the confidence using RANSAC to assign votes to the captured individual blocks. For example, while scoring each of the captured individual blocks P against corresponding blocks P′ of the enrolled image 108, the fingerprint identification system 104 assigns a confidence C to each of the respective scores R of the captured individual blocks P. The fingerprint identification system 104 then incrementally updates the confidence C that the user input matches the enrolled image 108 based on subsequent confidences C assigned to each of the respective scores R of the captured individual blocks P. For example, the fingerprint identification system 104 combines the respective confidences assigned to two or more highest-scoring of the captured individual blocks P. The two or more highest-scoring of the captured individual blocks each have similar rotational invariant vectors compared to the rotational invariant vector of each captured individual block's respective closest matching block P′ from the enrolled image 108. In other words, the two or more highest-scoring of the captured individual blocks P each have similar rotational invariant vectors as compared to respective rotational invariant vectors of respective closest matching blocks P′.

At 610, the fingerprint identification system 104 determines whether the blocks P being evaluated are the last blocks P of the total blocks M of the user input or if more blocks are available for evaluation. If not the last blocks P, the user device 100 repeats step 604 on a subsequent group of blocks P.

However, even if step 604 is being repeated on a subsequent group of blocks P, at 612, the user device 100 determines whether the confidence C satisfies a threshold for authenticating the enrolled user. If the confidence C does not satisfy the threshold, the user device 100, at 614, does not authenticate the fingerprint input and therefore does not authenticate the fingerprint input of the enrolled user. The user device 100 may determine, based on a summation of the votes assigned to the captured individual blocks P from the RANSAC, whether the confidence C satisfies a threshold for authenticating the user input. The user device 100 refrains from authenticating a fingerprint input unless the confidence is sufficient to indicate a match to the enrolled image 108. If the confidence C does satisfy the threshold, however, the user device 100, at 616, matches the fingerprint input to the enrolled image 108 to authenticate the fingerprint input. The fingerprint identification system 104 stops capturing and scoring any unscanned or remaining parts of the fingerprint input. The process repeats beginning at step 602 whenever a new fingerprint input is detected by the sensor 106.

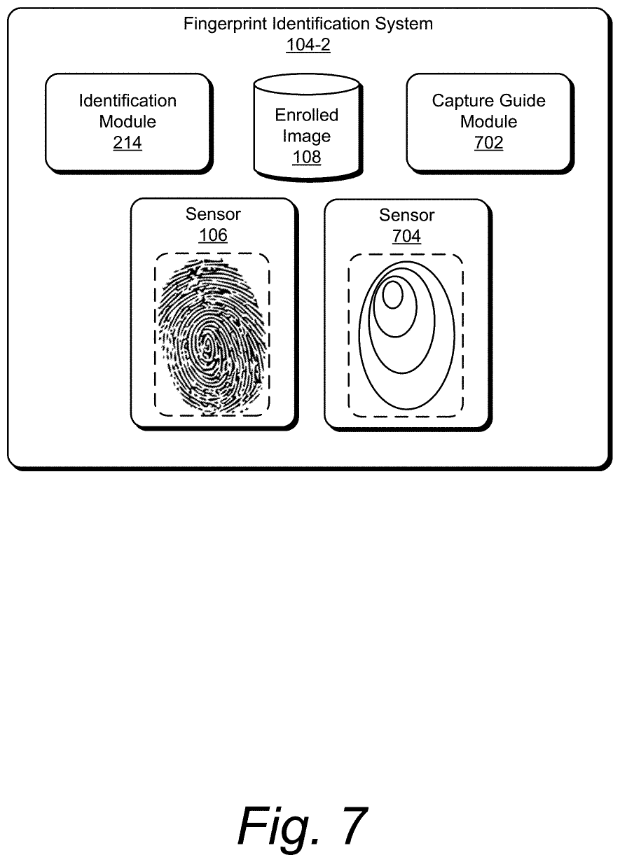

FIG. 7 illustrates an example of a fingerprint identification system 104-2 that implements parallel fingerprint capturing and matching with multiple sensors. The fingerprint identification system 104-2 includes the identification module 214, the enrolled image 108, the sensor 106, a capture guide module 702, and a sensor 704. The fingerprint identification system 104-2 fuses different sensor information to better identify a fingerprint.

The sensor 704 may sense temperature (heat) associated with user input. The sensor 704 may sense pressure or force associated with the user input. Any other type of sensor may be used as the sensor 704 to obtain additional information about a user input that can be used to authenticate it, such as capacitance.

The capture guide module 702 determines an order for capturing the blocks P of the user input detected by the sensors 106 and 704. For example, the order for capturing the blocks P may include starting with capturing blocks P nearest a centroid of the user input and iteratively capturing other blocks P outward from the center. In some examples, the capture guide module 702 directs the identification module 214 to capture a fingerprint with a spiral pattern starting from a centroid. Often times, the centroid corresponds to the warmest part of the user input.

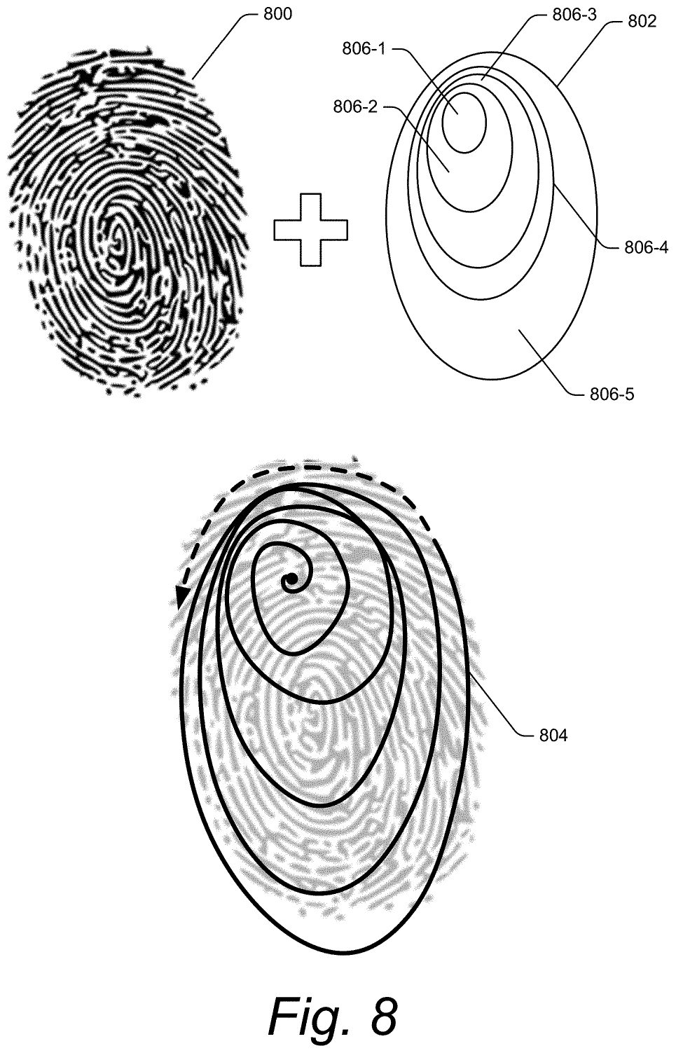

FIG. 8 illustrates an example capturing the path of the fingerprint identification system of FIG. 7. FIG. 8 shows how the capture guide module 702 may determine an order to capture the individual blocks P based on sensor data obtained from another sensor 704 of the user device, in addition to the sensor 106. When the sensor 704 measures temperature, the sensor 704 may provide the capture guide module 702 with a heat map of the user input. The capture guide module 702 identifies a center point of the heat map at which the temperature is greatest and directs the identification module 212 to capture the individual blocks P in the determined order beginning from the center point.

For example, the sensor 106 may produce a fingerprint image 800, and the sensor 704 may produce a heat map 802 with different temperature regions 806-1 through 806-5, with 806-5 being the coolest region and region 806-1 being the warmest. The capture guide module 702 may combine the sensor data to generate a capture path 804. This way, the fingerprint identification system 104-2 captures some of the individual blocks in the determined order beginning from the center point where the user input is warmest, and successively capturing the individual blocks of the user input spiraling outward from the centroid to subsequent regions 806 at which the heat map 802 indicates temperature is next highest.

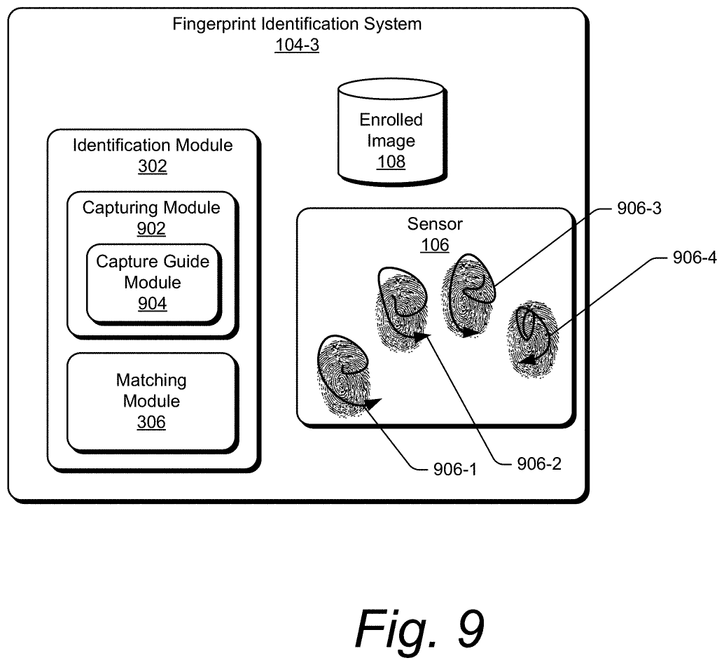

FIG. 9 illustrates an example of a fingerprint identification system that implements parallel fingerprint capturing and matching of multiple fingerprints along separate capturing paths. The fingerprint identification system 104-3 includes the enrolled image 108, the identification module 302, and the sensor 106. The identification module 302 includes the matching module 306 in addition to a capturing module 902. The capturing module 902 is similar to the capturing module 304; however, included in the capturing module 902 is a capture guide module 904, like the capture guide module 702 shown in FIG. 7.

In the example of FIG. 9, the sensor 106 receives a user input with multiple fingerprints. Rather than capture the entire user input, the capture guide module 904 recognizes from the sensor 106 when multiple touches are detected and generates a unique capture path 906-1 through 906-4 for each touch. The identification module 302 captures and matches the user input capturing blocks P along the capture paths 906-1 through 906-4 in parallel. All along, the identification module 302 checks whether the scores R or the confidence C determined from the captures that satisfy a threshold for authenticating the user input.

FIG. 10 illustrates examples of minutiae 1002 through 1022 used in matching fingerprints. The analysis of fingerprints for matching purposes generally requires the comparison of minutiae shown in FIG. 10. The three features of fingerprint ridges are the arch, the loop, and the whorl. An arch is a fingerprint ridge that enters from one side of the finger, rises in the center forming an arc, and then exits the other side of the finger. A loop is a fingerprint ridge that enters from one side of the finger, forms a curve, and then exits on that same side of the finger. A whorl is a fingerprint ridge that is circular around a central point. The minutiae 1002 through 1022 are features of fingerprint ridges, such as ridge ending, bifurcation, double bifurcation, trifurcation, short or independent ridge, island, lake or ridge enclosure, spur, bridge, delta, core, and so forth.

The following are additional examples of the described systems and techniques parallel capturing and matching of a fingerprint.

Example 1: A computer-implemented method comprising: detecting, by a user device, a fingerprint input at a fingerprint sensor; and while capturing, with the fingerprint sensor, portions of the fingerprint input, the portions representing individual blocks of the fingerprint input; scoring the captured individual blocks against respective enrolled blocks of an enrolled fingerprint input of an enrolled user; determining, based on respective scores of the captured individual blocks, a confidence that the fingerprint input matches the enrolled fingerprint input; and in response to the confidence satisfying a threshold, authenticating the fingerprint input.

Example 2: The method of example 1, wherein scoring each of the captured individual blocks against the corresponding blocks of the enrolled fingerprint input comprises: for each of the captured individual blocks, determining a rotational invariant vector relative to a closest matching block from the enrolled fingerprint input; and selecting, based on the rotational invariant vectors and from the corresponding blocks of the enrolled fingerprint input, a closest matching block for each of the captured individual blocks.

Example 3: The computer-implemented method of any of examples 1 or 2, wherein determining the confidence that the fingerprint input matches the enrolled fingerprint input comprises: while scoring each of the captured individual blocks against corresponding blocks of the enrolled image, assigning a respective confidence to each of the respective scores of the captured individual blocks; and incrementally updating the confidence that the fingerprint input matches the enrolled fingerprint input based on the respective confidence assigned to each of the respective scores of the captured individual blocks.

Example 4: The computer-implemented method of example 3, wherein incrementally updating the confidence that the fingerprint input matches the enrolled fingerprint input comprises combining the respective confidences assigned to two or more highest-scoring of the captured individual blocks.

Example 5: The computer-implemented method of example 4, wherein the two or more highest-scoring of the captured individual blocks each have similar rotational invariant vectors compared to respective rotational invariant vectors of respective closest matching blocks the enrolled fingerprint input.

Example 6: The computer-implemented method of any of examples 1 through 5, wherein determining the confidence of the fingerprint input comprises using random sample consensus to assign votes to the captured individual blocks.

Example 7: The computer-implemented method of example 6, further comprising: determining based on a summation of the votes assigned to the captured individual blocks, whether the confidence satisfies a threshold for authenticating the fingerprint input.

Example 8: The computer-implemented method of any of examples 1 through 7, wherein capturing the portion of the fingerprint input comprises: determining an order to capture the individual blocks based on sensor data obtained from another sensor of the user device, wherein the individual blocks are captured in the determined order.

Example 9: The computer-implemented method of example 8, wherein the sensor data is a heat map of the fingerprint input, the method further comprising: identifying a center point of the heat map at which temperature is greatest, wherein the individual blocks are captured in the determined order, including beginning the capturing of the individual blocks nearest the center point.

Example 10: The computer-implemented method of example 9, wherein the individual blocks are captured in the determined order including beginning the capturing of the individual blocks nearest the center point and subsequently capturing other blocks of the fingerprint input in regions of the heatmap where the temperatures are highest.

Example 11: The computer-implemented method of any of examples 1 through 10, wherein the captured individual blocks are square with a separation distance of at least one pixel.

Example 12: The computer-implemented method of any of examples 1 through 11, wherein the fingerprint input comprises a handprint including multiple fingerprints, the method further comprising: automatically matching the fingerprint input to the enrolled fingerprint input to authenticate the fingerprint input by automatically capturing and matching the multiple fingerprints in parallel.

Example 13: The computer-implemented method of any of example 12, wherein the fingerprint sensor comprises a large-area fingerprint sensor sufficient to capture and match blocks from multiple fingerprints in parallel.

Example 14: A computing system comprising at least one processor configured to perform any one of the computer-implemented methods of examples 1 through 13.

Example 15: A computer-readable storage medium comprising instructions that, when executed, cause at least one processor of a computing system to perform any one of the computer-implemented methods of examples 1 through 13.

While various embodiments of the disclosure are described in the foregoing description and shown in the drawings, it is to be understood that this disclosure is not limited thereto but may be variously embodied to practice within the scope of the following claims. From the foregoing description, it will be apparent that various changes may be made without departing from the spirit and scope of the disclosure as defined by the following claims.

1. A computer-implemented method comprising:
detecting, by a user device, a fingerprint input at a fingerprint sensor; and
while capturing, with the fingerprint sensor, portions of the fingerprint input, the portions representing individual blocks of the fingerprint input:
scoring the captured individual blocks against respective enrolled blocks of an enrolled fingerprint input of an enrolled user;
incrementally determining, based on respective scores of the captured individual blocks, a confidence that the fingerprint input matches the enrolled fingerprint input; and
in response to the confidence satisfying a threshold, authenticating the fingerprint input.

2. The method of claim 1, wherein scoring each of the captured individual blocks against the corresponding blocks of the enrolled fingerprint input comprises:
for each of the captured individual blocks, determining a rotational invariant vector relative to a closest matching block from the enrolled fingerprint input; and
selecting, based on the rotational invariant vectors and from the corresponding blocks of the enrolled fingerprint input, a closest matching block for each of the captured individual blocks.

3. The computer-implemented method of, claim 1, wherein incrementally determining the confidence that the fingerprint input matches the enrolled fingerprint input comprises:
while scoring each of the captured individual blocks against corresponding blocks of the enrolled image, assigning a respective confidence to each of the respective scores of the captured individual blocks; and
incrementally updating the confidence that the fingerprint input matches the enrolled fingerprint input based on the respective confidence assigned to each of the respective scores of the captured individual blocks.

4. The computer-implemented method of claim 3, wherein incrementally updating the confidence that the fingerprint input matches the enrolled fingerprint input comprises combining the respective confidences assigned to two or more highest-scoring of the captured individual blocks.

5. The computer-implemented method of claim 4, wherein the two or more highest-scoring of the captured individual blocks have similar rotational invariant vectors compared to respective rotational invariant vectors of respective closest matching blocks from the enrolled fingerprint input.

6. The computer-implemented method of, claim 1, wherein incrementally determining the confidence of the fingerprint input comprises using random sample consensus to assign votes to the captured individual blocks.

7. The computer-implemented method of claim 6, further comprising:
incrementally determining, based on a summation of the votes assigned to the captured individual blocks, whether the confidence satisfies the threshold for authenticating the fingerprint input.

8-15. (Canceled)

16. A computing system comprising:
a processor;
a fingerprint sensor operably coupled with the processor;
a fingerprint identification system executed by the processor, the fingerprint identification system configured to:
detect a fingerprint input at the fingerprint sensor; and
during capture of portions of the fingerprint input with the fingerprint sensor, the portions representing individual blocks of the fingerprint input:
score the captured individual blocks against respective enrolled blocks of an enrolled fingerprint input of an enrolled user;
determine, based on respective scores of the captured individual blocks, a confidence that the fingerprint input matches the enrolled fingerprint input; and
in response to the confidence satisfying a threshold, authenticate the fingerprint input.

17. The computing system of claim 16, wherein to score each of the captured individual blocks the fingerprint identification system is further configured to:
for each of the captured individual blocks, determine a rotational invariant vector relative to a closest matching block from the enrolled fingerprint input; and
select, based on the rotational invariant vectors and from the corresponding blocks of the enrolled fingerprint input, a closest matching block for each of the captured individual blocks.

18. The computing system of claim 16, wherein to determine the confidence that the fingerprint input matches the enrolled fingerprint input, the fingerprint identification system is further configured to:
while scoring each of the captured individual blocks against corresponding blocks of the enrolled image, assign a respective confidence to each of the respective scores of the captured individual blocks; and
update the confidence that the fingerprint input matches the enrolled fingerprint input based on the respective confidence assigned to each of the respective scores of the captured individual blocks.

19. The computing system of claim 18, wherein to update the confidence that the fingerprint input matches the enrolled fingerprint input, the fingerprint identification system is further configured to combine the respective confidences assigned to two or more highest-scoring of the captured individual blocks.

20. The computing system of claim 19, wherein the two or more highest-scoring of the captured individual blocks have similar rotational invariant vectors compared to respective rotational invariant vectors of respective closest matching blocks from the enrolled fingerprint input.

21. The computing system of claim 16, wherein the fingerprint identification system is further configured to:
determine an order to capture the individual blocks based on sensor data obtained from another sensor of the user device; and
capture the individual blocks using the determined order.

22. The computing system of claim 16, wherein the sensor data comprises a heat map of the fingerprint input and the fingerprint identification system is further configured to:
identify a center point of the heat map at which temperature is greatest; and
capture the individual blocks using the determined order starting from the individual blocks nearest the center point of the heat map.

23. A computer-readable storage medium comprising instructions that, when executed by one or more processors of a computing device, implement a fingerprint identification system to:
detect a fingerprint input at a fingerprint sensor operably coupled with the computing device; and
during capture of portions of the fingerprint input with the fingerprint sensor, the portions representing individual blocks of the fingerprint input:
score the captured individual blocks against respective enrolled blocks of an enrolled fingerprint input of an enrolled user;
determine, based on respective scores of the captured individual blocks, a confidence that the fingerprint input matches the enrolled fingerprint input; and
in response to the confidence satisfying a threshold, authenticate the fingerprint input.

24. The computer-readable storage medium of claim 23, wherein to score each of the captured individual blocks the fingerprint identification system is further implemented to:
for each of the captured individual blocks, determine a rotational invariant vector relative to a closest matching block from the enrolled fingerprint input; and
select, based on the rotational invariant vectors and from the corresponding blocks of the enrolled fingerprint input, a closest matching block for each of the captured individual blocks.

25. The computer-readable storage medium of claim 23, wherein to determine the confidence that the fingerprint input matches the enrolled fingerprint input, the fingerprint identification system is further implemented to:
while scoring each of the captured individual blocks against corresponding blocks of the enrolled image, assign a respective confidence to each of the respective scores of the captured individual blocks; and
update the confidence that the fingerprint input matches the enrolled fingerprint input based on the respective confidence assigned to each of the respective scores of the captured individual blocks.

26. The computer-readable storage medium of claim 25, wherein to update the confidence that the fingerprint input matches the enrolled fingerprint input, the fingerprint identification system is further implemented to combine the respective confidences assigned to two or more highest-scoring of the captured individual blocks.

27. The computer-readable storage medium of claim 26, wherein the two or more highest-scoring of the captured individual blocks have similar rotational invariant vectors compared to respective rotational invariant vectors of respective closest matching blocks from the enrolled fingerprint input.

28. The computer-readable storage medium of claim 23, wherein the fingerprint identification system is further implemented to:
determine an order to capture the individual blocks based on sensor data obtained from another sensor of the user device; and
capture the individual blocks using the determined order.
